(19) United States
(12) Patent Application Publication
(10) Pub. No.: US 2006/0075057 A1
(43) Pub. Date: Apr. 6, 2006

(54) Remote direct memory access system and method

(75) Inventors: Kevin J. Gildea, Bloomington, NY (US); Rama K. Govindaraju, Hopewell Junction, NY (US); Donald G. Grice, Gardiner, NY (US); Peter H. Hochschild, New York, NY (US); Fu Chung Chang, Rhinebeck, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, ARMONK, NY (US)

(21) Appl. No.: 10/929,943

(22) Filed: Aug. 30, 2004

(51) Int. Cl. G06F 15/167

(52) U.S. Cl. 709/212

(57) ABSTRACT

A remote direct memory access (RDMA) system is provided in which data is transferred over a network by DMA between from a memory of a first node of a multi-processor system having a plurality of nodes connected by a network and a memory of a second node of the multi-processor system. The system includes a first network adapter at the first node, operable to transmit data stored in the memory of the first node to a second node in a plurality of portions in fulfillment of a DMA request. The first network adapter is operable to transmit each portion together with identifying information and information identifying a location for storing the transmitted portion in the memory of the second node, such that each portion is capable of being received independently by the second node according to the identifying information. Each portion is further capable of being stored in the memory of the second node at the location identified by the location identifying information.

### BACKGROUND OF THE INVENTION

An important factor in the performance of a computer or a network of computers is the ease or difficulty with which data is accessed when needed during processing. To this end, direct memory access (DMA) was developed early on, to avoid a central processing unit (CPU) of a computer from having to manage transfers of data between long-term memory such as magnetic or optical memory, and short-term memory such as dynamic random access memory (DRAM), static random access memory (SRAM) or cache of the computer. Accordingly, memory controllers such as DMA controllers, cache controllers, hard disk controllers and optical disc controllers were developed to manage the transfer of data between such memory units, to allow the CPU to spend more time processing the accessed data. Such memory controllers manage the movement of data between the aforementioned memory units, in a manner that is either independent from or semi-independent from the operation of the CPU, through commands and responses to commands that are exchanged between the CPU and the respective memory controller by way of one or more lower protocol layers of an operating system that operate in background and take up little resources (time, memory) of the CPU.

However, in the case of networked computers, access to data located on other computers, referred to herein as “nodes”, has traditionally required management by an upper communication protocol layer running on the CPU of a node on the network. The lower layers of traditional asynchronous packet mode protocols, e.g., User Datagram Protocol (UDP) and Transport Control Protocol/Internet Protocol (TCP/IP), which run on a network adapter element of each node today, do not have sufficient capabilities to independently (without host side engagement in the movement of data) manage direct transfers of stored data between nodes of a network, referred to as “remote DMA” or “RDMA operations.” In addition, characteristics with respect to the transport of packets through a network was considered too unreliable to permit RDMA operations in such types of networks. In most asynchronous networks, packets that are inserted into a network in one order of transmission are subject to being received in a different order than the order in which they are transmitted. This occurs chiefly because networks almost always provide multiple paths between nodes, in which some paths involve a greater number of hops between intermediate nodes, e.g., bridges, routers, etc., than other paths and some paths may be more congested than others.

Prior art RDMA schemes could not tolerate receipt of packets in other than their order of transmission (e.g. Infiniband). In such systems, an RDMA message containing data written to or read from one node to another is divided up into a multiple packets and transmitted across a network between the two nodes. At the node receiving the message (the receiving node), the packets would then be placed in a buffer in the order received and the data payload extracted from the packets queued for copying into the memory of the receiving node. In such schemes, receipt of packets in the same order as transmitted is vital. Otherwise, the lower layer communication protocols could mistake the earlier arriving packets as being the earlier transmitted packets, even though earlier arriving packets might actually have been transmitted relatively late in the cycle. If a packet was received in a different order than it was transmitted, serious data integrity problems could result. For example, a packet containing data that is intended to be written to a first lower range of addresses of memory, is received prior to another packet containing data that is intended to be written to a higher range of addresses. If the reversed order of delivery went undetected, the data intended for the higher range of addresses could be written to the lower range of addresses, or vice versa. In addition, in such RDMA scheme, a packet belonging to a current more recently initiated operation could be mistaken for one belonging to an earlier operation that is about to finish. Alternate solutions to handle the out of order problem require the receiver to throw away packets that are received out of order and rely on the sending side adapter retransmitting packets not acknowledged by the receiver in a certain amount of time. Such schemes suffer from serious performance problems.

Accordingly, prior art RDMA schemes focused on enhancing network transport function to guarantee reliable delivery of packets across the network. Two such schemes are known as referred to as reliable connected and reliable datagram transport. With such reliable connected or reliable datagram transport, the packets of a message would be assured of arriving in the same order in which they are transmitted, thus avoiding the serious data integrity problems or performance problems which could otherwise result.

However, the prior art reliable connection and reliable datagram transport models for RDMA have many drawbacks. Transport of the packets of a message or “datagram” between the sending and receiving nodes is limited to a single communication path over the network that is selected prior to beginning data transmission from one node to the other. The existing schemes do not allow RDMA messages to be transported from one node to another across multiple paths through a network, i.e., to be “striped” across the network. It is well known in the art that striping of packets across multiple paths results in better randomization, and overall utilization of the switch while ensuring reduced contention and hot spotting in the switch network.

In addition, the reliable connection or reliable datagram transport models require that no more than a few packets be outstanding at any one time (the actual number depending on how many in-flight packets state can be maintained by the sending side hardware. Also, in order to further prevent packets from being received out of transmission order, transactions are assigned small timeout values, such that a timeout occurs unless the expected action (e.g. of receiving an acknowledgment for an injected packet) occurs within a short period of time. All of these restrictions impact the effective bandwidth that is apparent to a node for the transmission of RDMA messages across the network.

### SUMMARY OF THE INVENTION

According to an aspect of the invention, a remote direct memory access (RDMA) system is provided in which data is transferred over a network by DMA between a memory of a first node of a multi-processor system having a plurality of nodes connected by a network and a memory of a second node of the multi-processor system. The system includes a first network adapter at the first node, operable to transmit data stored in the memory of the first node to a second node in a plurality of portions in fulfillment of a DMA request. The first network adapter is operable to transmit each portion together with identifying information and information identifying a location for storing the transmitted portion in the memory of the second node, such that each portion is capable of being received independently by the second node according to the identifying information. Each portion is further capable of being stored in the memory of the second node at the location identified by the location identifying information.

According to another aspect of the invention, a method is provided for transferring data by direct memory access (DMA) over a network between a memory of a first node of a multi-processor system having a plurality of nodes connected by a network and a memory of a second node of the multi-processor system. Such method includes presenting to a first node a request for DMA access with respect to the second memory of the second node, and transmitting data stored in the memory of a sending node selected from the first and second nodes to a receiving node selected from the other one of the first and second nodes in a plurality of portions in fulfillment of the DMA request, wherein each portion is transmitted together with identifying information and information identifying a location for storing the portion in the memory of the receiving node. Thereafter, at least a portion of the plurality of transmitted portions are received at the receiving node, together with the identifying information and location identifying information. The data contained in the received portion is then stored at the location in the memory of the receiving node that is identified by the location identifying information.

According to a preferred aspect of the invention, each portion of the data is transmitted in a packet.

According to a preferred aspect of the invention, notification of the completion of a DMA operation between two nodes is provided at one or both of the node originating a DMA request and the destination node for the DMA request.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 illustrates a system and operation of remote direct memory access (RDMA) according to an embodiment of the invention;

FIG. 2 illustrates a communication protocol stack used to implement RDMA operations according to an embodiment of the invention;

FIG. 3 is a diagram illustrating a flow of control information and transfer of data in support of an RDMA write operation according to an embodiment of the invention; and

FIG. 4 is a diagram illustrating a flow of control information and transfer of data in support of an RDMA read operation according to an embodiment of the invention.

### DETAILED DESCRIPTION OF THE INVENTION

The advantages of using RDMA are manifold. RDMA can be used to reduce the number of times data is copied when sending data from one node to another. For example, some types of computer systems utilize staging buffers, e.g., first-in-first-out (FIFO) buffers, as a repository for transferring commands and data from a local memory of the node to be transferred to the network by a network adapter, and as a repository for commands and data arriving from the network through the network adapter, prior to being copied to the node's local memory. Using RDMA, the data to be transferred need no longer be copied into a send staging buffer, e.g., a send FIFO, prior to being copied into the memory of the network adapter to create outgoing packets. Instead, by use of RDMA, the data is copied directly from the task address space into the adapter memory, avoiding the additional copy.

Likewise, using RDMA, the data being received need no longer be copied into a receive staging buffer, e.g., a receive FIFO, prior to being copied into the node's local memory, but rather the data is copied directly from the memory of the network adapter to the node's local memory.

Another advantage is that tasks running on one node have the ability to request to put or get data stored on other nodes in a way that is transparent to that node, the data being requested in the same manner by the task as if it were stored locally on the requesting node.

In addition, the upper layer protocol and the processor of a node are not directly involved in the fragmentation and reassembly of messages for transport of the network. Using RDMA, such operation is successfully offloaded to the level of the adapter microcode operating on a network adapter of the node.

A further advantage of RDMA of the embodiments of the invention described herein is that RDMA related interrupts are minimized on the node which acts as the “slave” under the direction of a “master” or originating node.

In the embodiments of the invention described herein, reliable RDMA operation is provided in a network that does not provide reliable connection or reliable datagram transport, i.e., a network in which the delivery of packets within a message is not considered reliable. According to the embodiments of the invention described herein, packets delivered to a node at a receiving end of an RDMA operation in a different order than the order in which they are sent thereto from the transmitting end of the operation poses no problem because the packets are self-describing. The self-describing packets allow a lower layer protocol at the receiving end to store the data received in each packet to the proper place in local memory allocated to a task at the receiving end, even if the packets are received in a different order than that in which they were transmitted.

Moreover, elimination of the requirement for reliable connection or reliable datagram transport allows RDMA to be implemented in networks that carry data more efficiently and are more robust than networks such as those described above which implement a reliable delivery model having reliable connection or reliable datagram transport. This is because the reliable datagram networks limit the transport of packets of an RDMA message to a single communication path over the network, in order to assure that packets are delivered in order. The requirement of a single communication path limited the bandwidth for transmitting packets. Moreover, if a problem along the selected communication path interfered with the transmission of packets thereon, a new communication path through the network had to be selected and the message re-transmitted from the beginning.

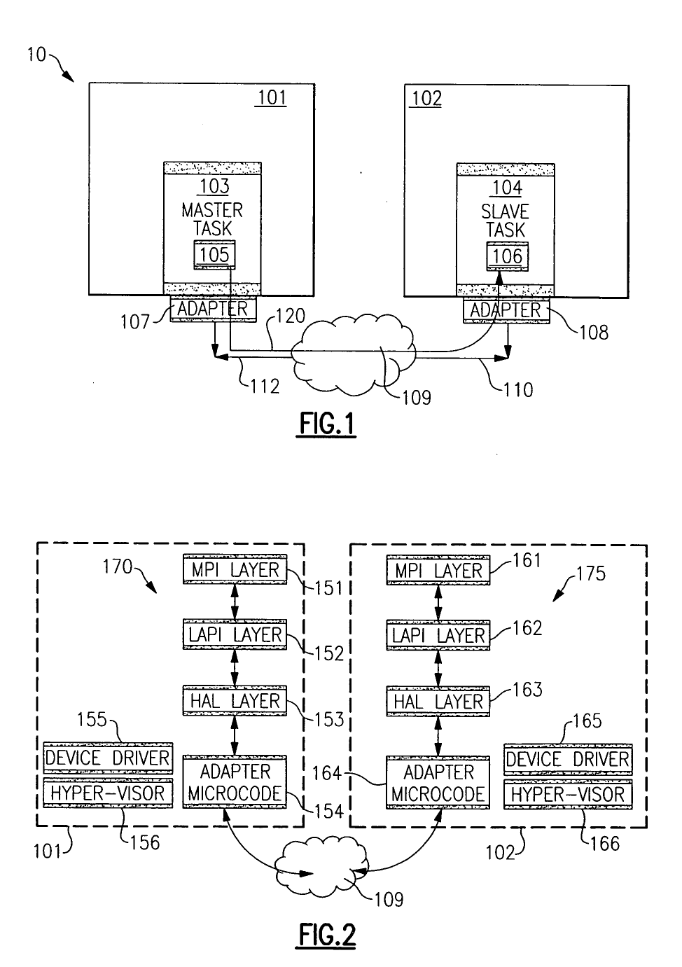

FIG. 1 is a diagram illustrating principles of remote direct memory access (RDMA) according to an embodiment of the invention. Nodes 101 and 102 are computers of a multi-processor system having a plurality of nodes connected by a network 10, as interconnected by network adapters 107, 108, a switching network 109, and links 110 and 112 between network adapters 107, 108 and the switching network 109. Within switching network 109 there are typically one or more local area networks and/or one or more wide area networks, such network(s) having a plurality of links that are interconnected by communications routing devices, e.g., switches, routers, and bridges. As such, the switching network 109 typically provides several alternative paths for communication between the network adapter 107 at node 101 and network adapter 108 at node 102.

As will be described more fully below, the network 10 including nodes 101, 102 and switching network 109 need not have a reliable connection or reliable datagram transport mechanism. Rather, in the embodiments of the invention described herein, RDMA can be performed in a network having an unreliable connection or unreliable datagram transport mechanism, i.e., one in which packets of a communication between nodes, e.g., a message, are received out of the order in which they are transmitted. Stated another way, in such network a packet that is transmitted for an outgoing transmission at an earlier time than another may actually be received later than one which is transmitted later. When the switching network 109 includes a plurality of paths for communication between nodes 101 and 102, and the packets of that communication are transmitted over different paths, it is likely that the packets will be received out of transmission order at least some of the time.

The nodes 101, 102 each include a processor (not shown) and memory (not shown), both of which are utilized for execution of processes, which may also be referred to as “tasks”. As further shown in FIG. 1, one or more tasks (processes) 103 and 104 are executing on nodes 101 and 102, respectively. Typically, many tasks execute concurrently on each node. For simplicity, the following description will refer only to one task per node. Task 103 has access to the memory of the node 101 on which it runs, in terms of an address space 105 assigned to the task. Similarly, task 104 has access to the memory of node 102 on which it runs, in terms of an address space 106 assigned to that task.

Using RDMA, task 103 running on node 101, is able to read from and write to the address space 106 of task 104, in a manner similar to reading from and writing to its own address space 105. Similarly, utilizing RDMA, task 104 running on node 102 is able to read from and write to the address space 105 of task 103, also in a manner similar to reading from and writing to its own address space 106. For RDMA enabled processing, each of the tasks 103 and 104 is a cooperating process, such that for each task, e.g., task 103, at least some portion of its address space, e.g. address space 105, is accessible by another cooperating process. FIG. 1 illustrates a two-task example. However, the number of cooperating processes is not limited for RDMA operations. Thus, the number of cooperating processes can be any number from two processes to very many.

In FIG. 1, master task 103 on node 101 is shown initiating an RDMA write operation to read data from the address space 106 of task 104 on node 102 into its own address space labeled 105. The RDMA transport protocol enables this data transfer to occur without the active engagement of the slave task, i.e. without requiring the an upper protocol layer operating on node 102 to be actively engaged to support the RDMA data transfer to slave task 104.

FIG. 2 show illustrative communication protocol and node software stacks 170, 175 in which RDMA is implemented according to an embodiment of the invention. Stack 170 runs on node 101, and stack 175 runs on node 102. Many other types of protocol stacks are possible. FIG. 2 illustrates only one of many environments in which RDMA can be implemented according to embodiments of the invention. In FIG. 2, message passing interface (MPI) layers 151, 161 are upper protocol layers that run on respective nodes that enforce MPI semantics for managing the interface between a task executing on one of the respective nodes and the lower protocol layers of the stack. Collective communication operations are broken down by MPI into point-to-point lower layer application programming interface (LAPI) calls. The MPI translates data type layout definitions received from an operating task into appropriate constructs that are understood by the lower layers LAPI and the HAL layer. Typically, message matching rules are managed by the MPI layer.

The LAPI layer, e.g., layer 152 of protocol stack 170, and layer 162 of protocol stack 175, provides a reliable transport layer for point-to-point communications. LAPI maintains state for messages and packets in transit between the respective node and another node of the network 10, and re-drives any packets and messages when they are not acknowledged by the receiving node within an expected time interval. In operation, the LAPI layer packetizes non-RDMA messages into an output staging buffer of the node, such buffer being, illustratively, a send first-in-first-out (herein SFIFO) buffer maintained by the HAL (hardware abstraction layer) 153 of the protocol stack 170. Typically, HAL 153 maintains one SFIFO and one receive FIFO (herein RFIFO) (an input staging buffer for receiving incoming packets) for each task that runs on the node. Non-RDMA packets arriving at the receiving node from another node are first put into a RFIFO. Thereafter, the data from the buffered packets are moved into a target user buffer, e.g. address space 105, used by a task, e.g. task 103, running on that node.

On the other hand, for RDMA messages, the LAPI layer uses HAL 153 and a device driver 155, to set up message buffers for incoming and outgoing RDMA messages, by pinning the pages of the message buffers and translating the messages. The state for re-driving messages is maintained in the LAPI layer, unlike other RDMA capable networks such as the above-described reliable connection or reliable datagram networks in which such state is maintained in the HAL, adapter, or switch layer. Maintenance of state by the LAPI layer, rather than a lower layer of the stack 170 such as HAL or the adapter layer (FIG. 2) enables RDMA to be conducted reliably over an unreliable datagram service.

The HAL layer, e.g., layer 153 of protocol stack 170 on node 101, and layer 163 of stack 175 on another node 102, is the layer that provides hardware abstraction to an upper layer protocol (ULP), such ULP including one or more of the protocol layers LAPI and MPI, for example. The HAL layer is stateless with respect to the ULP. The only state HAL maintains is that which is necessary for the ULP to interface with the network adapter on the particular node. The HAL layer is used to exchange RDMA control messages between the ULP and the adapter microcode. The control messages include commands to initiate transfers, to signal the completion of operations and to cancel RDMA operations that are in-progress.

The adapter microcode 154, operating on a network adapter 107 of a node 101 (FIG. 1), is used to interface with the HAL layer 153 for RDMA commands, and to exchange information regarding completed operations, as well as cancelled operations. In addition, the adapter microcode 154 is responsible to fragment and reassemble RDMA messages, to copy data out of one user buffer 103 for a task running on the node 101, to adapter memory for transport to network, and to move incoming data received from the network into a user buffer for the receiving task.

RDMA operations require adapter state. This state is stored as transaction information on each node in a data structure referred to herein as an RDMA context, or simply an “RCXT”. RCXTs are preferably stored in static random access memory (SRAM) maintained by the adapter. Each RCXT is capable of storing the transaction information including the state information required for one active RDMA operation. This state information includes a linked list pointer, a local channel id, two virtual addresses, the payload length, and identification of the adapter (“adapter id”) that initiates the transaction, as well as an identification of a channel (“channel id”). The state information for example is approximately 32 bytes total in length. The RCXT structure declaration follows.

Typedef enum {

| | |
|---|---|
| Idle | = 0, |
| SourcingPayload | = 1, /* Transmitting RDMA payload */ |
| SinkingPayload | = 2, /* Receiving RDMA payload */ |
| SendingCompletion | = 3 |
| } RCXT_state_t; | |
| Typedef Struct { | |

| | | |
|---|---|---|
| uint8_t_{—} | channel; | /* Owning channel */ |

| | | |
|---|---|---|
| RCXT_t | *next; | /* next busy RCXT |
| */ | | |

| | | |
|---|---|---|
| uint64_t | TID; | /* Transaction id */ |

| | | |
|---|---|---|
| RCXT_state_t | state; | /* RCXT State */ |

| | | |
|---|---|---|
| uint64_t | src_address; | /* next lcl v_addr */ |
| uint64_t | tar_address; | /* next rmt v_addr */ |

| uint32 t | length; | /* rem payload len */ |
|---|---|---|
| uint16_t | initiator_adapter_id; | |
| uint8_t | initiator_channel_id; | |
| uint24_t | initiator_RCXT; | /* Only for RDMAR */ |
| uint4_t | outstandingDMA; | /* # of in-progress DMAs */ |

} RCXT_t;

According to the foregoing definition, the RCXT has approximately 1+8+8+8+8+4+2+1+3+4=47 bytes.

The ULPs purchase RCXT's from the local device driver for the node, e.g., node 101, or from another resource manager of the node or elsewhere in the multi-processor system, according to predetermined rules for obtaining access to limited system resources in the node and system. At the time of purchase, the ULP specifies the channel for which the RCXT is valid. Upon purchase (via a privileged memory mapped input output (MMIO) operation or directly by the device driver) the channel number is burned into the RCXT. The pool of RCXTs is large, preferably on the order of 100,000 available RCXTs. Preferably, the ULP has the responsibility for allocating local RCXT's to its communicating partners, in accordance with whatever policy (static or dynamic) selected by the ULP.

Moreover, the ULP also has responsibility to assure that at most one transaction is pending against each RCXT at any given time. The RDMA protocol uses transaction identification (“transaction id”, or “TID”) values to guarantee “at most once” delivery. Such a guarantee is required to avoid accidental corruption of registered memory. A TID is specified by the ULP each time it posts an RDMA operation. When the RCXT is first purchased by the ULP, the TID is set to zero. For each RCXT used, the ULP must choose a higher TID value than that used for the last previous RDMA transaction using that RCXT. The TID posted by the ULP for an RDMA operation is validated against the TID field of the targeted RCXT. The detailed TID validation rules are described later.

The TID is a sequence number that is local to the scope of an RDMA operation identified by a source (“src”), i.e., the initiating node, and to the RCXT. The chief reasons for using the RCXT and TID are to move the responsibility for exactly-once delivery of messages as much as possible from firmware (microcode) to the ULP. The RCXT and TID are used by the microcode to enforce at-most-once delivery and to discard possible trickle traffic. As described above, under the prior art RDMA model, short timeouts and restriction to a single communication path was used to prevent packets belonging to an earlier transmitted RDMA message from being confused with the packets of an RDMA message that occurs later. In the embodiment of the invention here, the ULP uses the RCXT and TID fields of received packets to validate the packets and guarantee exactly-once delivery.

Moreover, the RDMA strategy described herein simplifies the management of timeouts by having it performed in one place, the ULP.RDMA according to embodiments of the invention described herein eliminates the need for multiple layers of reliability mechanisms and re-drive mechanisms in the HAL, the adapter layer and the switch layer protocol, as provided according to the prior art. By having timeouts all managed by the ULP, RDMA operations can proceed more efficiently, with less latency. The design of communication protocol layers in support of RDMA is also simplified. Such timeout management additionally appears to improve the effective bandwidth across a large network, by eliminating a requirement of the prior art RDMA scheme that adapter resources be locked until an end-to-end echo is received.

In operation, the adapter microcode 154 on one node that sends data to another node copies data from a user buffer, e.g., 105 (FIG. 1) on that node, fragments the packets of a message and injects the packets into the switch network 109. Thereafter, the adapter microcode 164 of the node receiving the data reassembles the incoming RDMA packets and places data extracted from the packets into a user buffer, e.g., 106 (FIG. 1) for the receiving node. If necessary, the adapter microcode 154 at a node 101 at one end of a transmitting operation, for example, the sending end, and the adapter microcode 164 at the other end can also generate interrupts through the device driver 155 at the one end, or the device driver 165 at the other end, for appropriate ULP notification. The choice of whether notification is to occur at the sending end, the receiving end, or both is selected by the ULP.

Each device driver 155 (or 165) is used to set up HAL FIFOs (a SFIFO and an RFIFO) to permit the ULP managing a task 103 at node 101 to interact with the corresponding adapter 107. The device driver also has responsibilities to field adapter interrupts, open, close, initialize, etc. and other control operations. The device driver is also responsible to provide services to pin and perform address translation for locations in the user buffers to implement RDMA. Locations in user buffers are “pinned” such that the data contained therein are not subsequently moved, as by a memory manager, to another location within the computer system, e.g., tape or magnetic disk storage. Address translation is performed to convert virtual addresses provided by the ULP into real addresses which are needed by the adapter layer to physically access particular locations. For efficient RDMA, the data to be transferred must remain in a known, fixed location throughout the RDMA transfer (read or write) operation. The hyper-visor layer 156 of stack 170 on node 101, and hyper-visor layer 166 of stack 175 on node 102, is the layer that interacts with the device driver to set up translation entries.

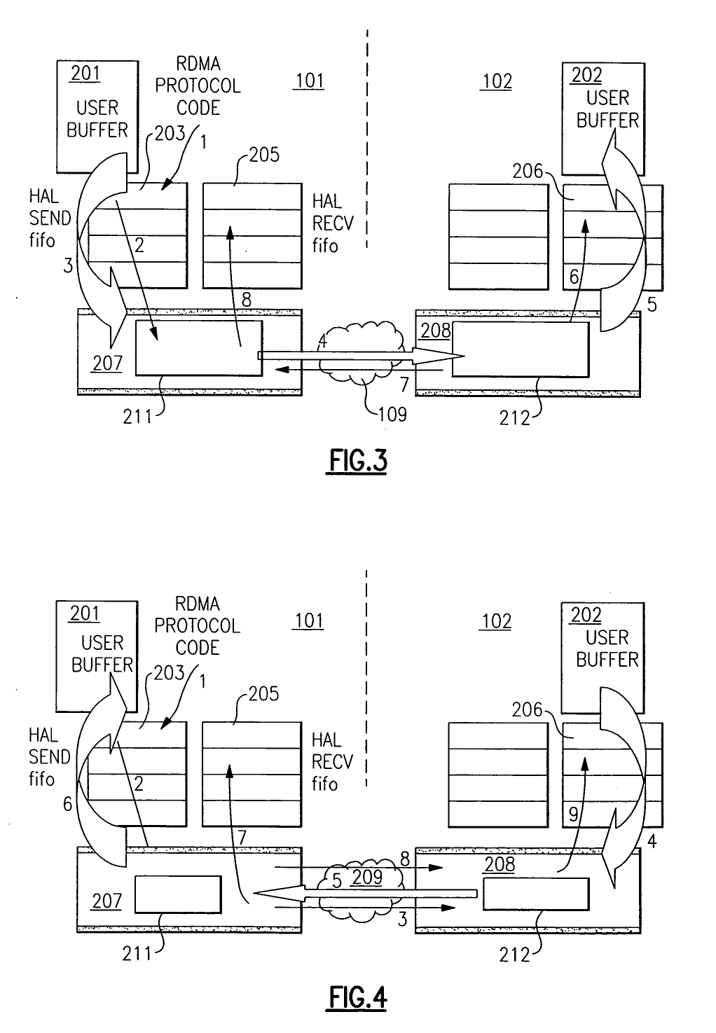

FIG. 3 illustrates the performance of an RDMA write operation between a user buffer 201 of a task running on a first node 101 of a network, and a user buffer 202 of a task running on a second node 102 of the network. In FIG. 2, the smaller arrows 1, 2, 6, 7, 8 show the flow of control information, while the large arrows 3, 4, and 5 show the transfers of data.

With combined reference to FIGS. 1 through 3, in an example of operation, a task 103 running on node 101 initiates an RDMA write operation to write data from its user buffer 105 to a user buffer 106 owned by a task 104 running on node 102. Task 103 starts the RDMA write operation through an RDMA write request posted as a call from an upper layer protocol (ULP), e.g., the MPI, and/or LAPI into a HAL send FIFO 203 for that node. For such request, task 103 operates as the “master” to initiate an RDMA operation and to control the operations performed in support thereof, while task 104 operates as a “slave” in performing operations required by task 103, the slave being the object of the RDMA request. A particular task need only be the “master” for a particular RDMA request, while another task running on another node can be master for a different RDMA operation that is conducted either simultaneously with the particular RDMA operation or at another time. Likewise, task 103 on node 101, which is “master” for the particular RDMA write request, can also be “slave” for another RDMA read or write request being fulfilled either simultaneously thereto or at a different time.

The RDMA write request is a control packet containing information needed for the adapter microcode 154 on node 101 to perform the RDMA transfer of data from the user buffer 201 of the master task 103 on node 101 to the user buffer 202 of the slave task on node 102. The RDMA write request resembles a header-only pseudo-packet, containing no data to be transferred. The RDMA write request is one of three types of such requests, each having a flag that indicates whether the request is for RDMA write, RDMA read or a normal packet mode operation. The RDMA write request includes a) a starting address of the source data in user buffer 201 to be transferred, b) the starting address of the target area in the user buffer 202 to receive the transferred data, and c) the length of the data (number of bytes, etc.) that are to be transferred by the RDMA operation. The RDMA request also identifies the respective RCXTs that are to be used during the RDMA operation by the HAL and by the adapter microcode layers on each of the sending nodes 101 and 102. The RDMA request preferably also includes a notification model, such model indicating whether the ULP of the master task, that of the slave task, or both, should be notified when the requested RDMA operation completes. Completion notification is provided because RDMA operations might fail to complete on rare occasions, since the underlying network transport model is unreliable. In such event, the ULP will be responsible for retrying the failed operation.

After the RDMA request is placed in the HAL send FIFO 203 of node 101, the HAL 153 notifies the adapter microcode 154, and receives therefrom in return an acknowledgment of the new pending request. The adapter microcode 154 then receives the RDMA request packet into its own local memory (not shown) and parses it. By this process, the adapter microcode extracts the information from the RDMA request packet which is necessary to perform the requested RDMA operation. The adapter microcode copies relevant parameters for performing the RDMA operation into the appropriate RCXT structure, the RCXT being the data structure where state information for performing the transaction is kept. The parameters stored in the RCXT include the adapter id of the sending adapter 107 and the receiving adapter 108, as well as the channel ids on both the sending and receiving adapters, the transaction id (TID), the target RCXT used on the target (slave) node, the length of the message, the present address locations of the data to be transferred, and the address locations to which the transferred data is to be transferred.

The adapter microcode 154 then copies the data to be written by the RDMA operation from the user buffer 201 by DMA (direct memory access) method, i.e., without involvement of the ULP, into the local memory 211 of the adapter 207. Thereafter, the microcode 154 parses and formats the data into self-describing packets to be transferred to the adapter 208 of node 102, and injects (transmits) the packets into the network 109 as an RDMA message for delivery to adapter 208. As each packet is injected into the network 109, the state of the RCXT, including the length of data yet to be transferred, is updated appropriately. This is referred to as the “sourcing payload” part of the operation. When all data containing packets for the RDMA write request have been sent by the adapter, the adapter microcode 154 marks the request as being completed from the standpoint of the sender side of the operation.

The packets of the RDMA write message then begin arriving from the network 109 at the adapter 208 of the receiving node 102. Due to the less constrained network characteristics, the packets may arrive in a different order than that in which they are transmitted by the adapter microcode 154 at adapter 207. Since the packets are self-describing, adapter microcode 164 at node 102 is able to receive the packets in any order and copy the data payload therein into the user buffer 202 for the slave task, without needing to arrange the packets by time of transmission, and without waiting for other earlier transmitted packets to arrive. The self-describing information that is provided with each packet is the RCXT, a transaction identification (TID) which identifies the particular RDMA operation, an offset virtual address to which the data payload of the packet is to be stored in the user buffer, and a total data length of the payload. Such information is provided in the header of each transmitted packet. With this information, the adapter microcode determines a location in the user buffer 202 (as by address translation) to which the data payload of each packet is to be written, and then transfers the data received in the packet by a DMA operation to the identified memory location in the user buffer 202. At such time, the adapter microcode 164 also updates the total data payload received in the RCXT to reflect the added amount of data received in the packet. In addition, the adapter microcode 164 compares the total length of the data payload received thus far, including the data contained in the incoming packet, against the length of the remaining data payload yet to be received, as specified in the RCXT at the receiving adapter. Based on such comparison, the receiving adapter 208 determines whether any more data payload-carrying packets are awaited for the RDMA message.

In such manner, the identity of the pending RDMA operation and the progress of the RDMA operation are determined from each packet arriving from the network 109. To further illustrate such operation, assume that the first packet of a new RDMA message arrives at a receiving adapter 208 from a sending adapter 207. The RCXT and the TID are extracted from the received packet. When the TID extracted from the arriving packet is a new one to be used for the particular RCXT, this signals the receiving adapter that the packet belongs to a new message of a new RDMA operation. In such case, the receiving adapter 208 initializes the RCXT specified in the RDMA packet for the new RDMA operation.

Note that the first data payload packet to be received by the receiving adapter 208 need not be the first one that is transmitted by the sending adapter 207. As each packet of the message arrives at the receiving adapter 208, progress of the RDMA operation is tracked by updating a field of the RCXT indicating the cumulative total data payload length received for the message. This is referred to as the “sinking payload” part of the operation. Once all the packets of the message have been received, the adapter microcode 164 completes the operation by DMA transferring the received packet data from the adapter memory 212 to the user buffer 202.

Thereafter, the adapter microcode 164 signals that all packets of the DMA operation have been received, by inserting a completion packet into the HAL receive FIFO 206 for node 102. This is preferably done only when the task 103 has requested such completion notification for the RDMA operation, as made initially by the ULP on node 101. In addition, when completion notification is requested, the adapter microcode 164 of the receiving adapter constructs a completion notification packet and sends it to the sending adapter 207.

Thereafter, the adapter microcode 154 on the sending side 207 places the completion notification packet received from the receiving adapter 208 into the HAL receive FIFO 205 of node 101. Arrows 6, 7 and 8 represent steps in the sending of completion notifications.

The ULPs at node 101 at the sending side for the operation and node 102 at the receiving side read the completion packets and are signaled thereby to clean up state with respect to the RDMA operation. If completion packets are not received for the RDMA operations in a reasonable amount of time, a cancel operation is initiated by the ULPs to clean up the pending RDMA state in the RCXT structures and to re-drive the messages.

FIG. 4 illustrates a flow of control information and data supporting an RDMA read operation between a first node 101 and a second node 102 of a network. The sequence of operations that occur in support of an RDMA read operation are similar to that of the above-described RDMA write operation, when viewed from the point of view that the RDMA read operation is like an RDMA write operation, except that the slave task actually transfers (“writes”) the data that is read from its user buffer back to the user buffer of the master task.

An RDMA read operation is now described, with reference to FIGS. 1, 2 and 4. In an RDMA read operation, the ULP on the master task 103 running on a node 101 submits an RDMA read request into the HAL send FIFO 203. Thereafter, HAL handshakes with the network adapter 207 and the adapter then transfers the command by DMA operation into its own memory 211. The adapter then decodes the request as an RDMA read request and initializes the appropriate RCXT with the relevant information to be used as the “sink”, the receiving location, for the RDMA data transfer.

Next, the adapter 207 forwards the RDMA read command in a packet to the network adapter 208 at the location of the slave task 104. The slave side adapter 208 initializes the appropriate RCXT with the TID, message length, and appropriate addresses and starts DMAing the data from the user buffer 202 maintained by the slave task 104 into the adapter 208, and then injecting the packets into the network. The state variables maintained in the RCXT, e.g., lengths of data payload transmitted, etc., are updated with each packet injected into the network for delivery to the network adapter 207 on which the master task 103 is active.

With each arriving data packet, the master side adapter 208 at node 101 transfers the data extracted from the packet by a DMA operation at the offset address indicated by the packet into the user buffer in the local memory of the node 101. The RCXT is then also updated appropriately with the arrival of each packet. Once the entire message has been assembled into the user buffer the adapter 207 then places a completion notification (if requested) into the receive FIFO 205 utilized by the master task 103 (step 7). When completion notification is requested by the slave side adapter 208, the adapter 207 sends such notification to the slave side adapter 208, and the slave side adapter 208 transfers the completion packet by DMA operation into the receive FIFO 206 for the slave task 104 at node 102.

Optionally, fencing may be performed at completion of the RDMA (write or read) operation. Such fencing can be performed, e.g., by sending a “snowplow” packet that awaits acknowledgement until all packets outstanding from prior RDMA requests have been forwarded into the node at which they are designated to be received. In such manner, coherency between the memories of the sending and receiving nodes can be assured.

As described in the foregoing, the embodiments of the invention allow RDMA to be performed over an unreliable connection or unreliable datagram delivery service, in a way that takes advantage of multiple independent paths that are available through a network between a source and destination pair of nodes. Packets of a message can be sent in a round robin fashion across all of the available paths, resulting in improved utilization of the switching network 109, and minimizing contention for resources and potential network delays resulting therefrom. Packets arriving out of order at the receiving end are managed automatically due to the self-describing nature of the packets. No additional buffering is required to handle the arrival of packets at a receiver in an order different from that in which they are transmitted. No additional state maintenance is required to be able to handle the out of order packets.

The following is provided as additional information showing structure declarations for illustrative types of RDMA packets:

Typedef enum {

| | | |
|---|---|---|
| None | = 0, | /* “Completed ok” */ |
| Message | = 1, | /* Packet-mode message */ |
| RDMAWRequest | = 2, | /* RDMAW request */ |
| RDMARRequest | = 3, | /* RDMAR request */ |
| RDMAWPayload | = 4, | /* RDMAW payload */ |
| RDMARPayload | = 5, | /* RDMAR payload */ |
| RDMAWCompletion | = 6, | /* RDMAW Completion */ |
| RDMARCompletion | = 7, | /* RDMAR Completion */ |
| Corrupt | = 8, | /* “Completed in error” */ |

} PacketType_t;
Typedef Struct {

| | | |
|---|---|---|
| PacketType | type; | /* Type of packet */ |
| uint16_t | adapterId; | /* Source or Dest */ |
| uint8_t | channelId; | /* Source or Dest */ |
| uint16_t | payloadLen; | |
| uint64_t | protectionKey; | /* Inserted by ucode */ |

} BaseHeader_t;
Typedef Struct {

| | | |
|---|---|---|
| uint24_t | RCXT; | /* Destination RCXT */ |
| uint64_t | TID; | /* Transaction id */ |
| uint32_t | rdmaLength; | /* Total RDMA length */ |
| uint64_t | virtAddr; | /* Destination vAddr */ |

} RDMA_Payload_Extended_Header_t;
Typedef Struct {

| | | |
|---|---|---|
| uint24_t | RCXT; | /* Target-side RCXT */ |
| uint64_t | TID; | /* Transaction id */ |
| uint32_t | rdmaLength; | /* Total RDMA length */ |
| uint64_t | lclVirtAddr; | /* Source (local) vAddr */ |
| uint64_t | remVirtAddr; | /* Destination (remote) vAddr */ |

} RDMAW_Request_Extended_Header_t;
Typedef Struct {

| | | |
|---|---|---|
| uint24_t | tar_RCXT; | /* Target-side RCXT */ |
| uint24_t | lcl_RCXT; | /* Initiator-side RCXT */ |
| uint64_t | TID; | /* Transaction id */ |
| uint32_t | rdmaLength; | /* Total RDMA length */ |
| uint64_t | lclVirtAddr; | /* Destination (local) vAddr */ |
| uint64_t | remVirtAddr; | /* Source (remote) vAddr */ |

} RDMAR_Request_Extended_Header_t;
Typedef Struct {

| | | |
|---|---|---|
| uint24_t | RCXT; | /* Target-side RCXT */ |
| uint64_t | TID; | /* Transaction id */ |

} RDMAW_Completion_Extended_Header_t;
Typedef Struct {

| | | |
|---|---|---|
| uint24_t | tar_RCXT; | /* Target-side RCXT */ |
| uint24_t | lcl_RCXT; | /* Initiator-side RCXT */ |
| uint64_t | TID; | /* Transaction id */ |

} RDMAR_Completion_Extended_Header_t;

Accordingly, while the invention has been described in detail herein in accord with certain preferred embodiments thereof, still other modifications and changes therein may be effected by those skilled in the art. Accordingly, it is intended by the appended claims to cover all such modifications and changes as fall within the true spirit and scope of the invention.

What is claimed is:

1. A method of transferring data by direct memory access (DMA) over a network between a memory of a first node of a multi-processor system having a plurality of nodes connected by a network and a memory of a second node of the multi-processor system, comprising:
presenting to a first node a DMA request with respect to the second memory of the second node;
transmitting data stored in the memory of a sending node selected from the first and second nodes to a receiving node selected from the other one of the first and second nodes in a plurality of portions in fulfillment of the DMA request, each portion transmitted together with identifying information and information identifying a location for storing the portion in the memory of the receiving node;
receiving at the receiving node at least a portion of the plurality of transmitted portions together with the identifying information and location identifying information; and
storing the data contained in the received portion at the location in the memory of the receiving node identified by the location identifying information.

2. A method as claimed in claim 1, wherein the received portion is validated using the received identifying information prior to being stored at the location in the memory of the receiving node.

3. A method as claimed in claim 1, further comprising storing transaction information for monitoring fulfillment of the DMA request at the receiving node, and updating the stored transaction information at the receiving node after validating the received portion.

4. A method as claimed in claim 3, wherein the DMA request is presented to the first node by an upper layer protocol, the upper layer protocol maintaining state regarding the DMA request with the transaction information, the method further comprising, re-driving the DMA request when the DMA request fails to complete within a predetermined period of time.

5. A method as claimed in claim 3, wherein the transaction information includes a source base address of the data to be transferred by the DMA request from the sending node, a destination base address to which the data transferred by the DMA request is to be stored at the second node, and a transfer length indicating an amount of data to be transferred by the DMA request and the location identifying information includes an offset address calculated from the destination base address.

6. A method as claimed in claim 5, wherein the transaction information further includes information identifying communication resources used in fulfillment of the DMA request.

7. A method as claimed in claim 6, wherein the information identifying communication resources identifies a first network adapter of the first node, a first channel of the first network adapter, a second network adapter of the second node, and a second channel of the second network adapter, all of the first and second network adapters and first and second channels being used in fulfillment of the DMA request.

8. A method as claimed in claim 3, wherein the identifying information and the location identifying information are provided in a header transmitted with each portion, the header referencing the transaction information.

9. A method as claimed in claim 8, further comprising, for each received portion, validating the header with the transaction information stored at the receiving node and dropping the received portion when the transmitted header fails to validate.

10. A method as claimed in claim 1, wherein the DMA request specifies a write operation from the sending node to the receiving node.

11. A method as claimed in claim 3, further comprising transmitting notification of completion by the receiving node to the sending node when the transaction information is updated to indicate that fulfillment of the DMA request has been completed.

12. A method as claimed in claim 11, further comprising receiving the notification of completion at the sending node and performing fencing to validate coherency of the memories of the sending and receiving nodes.

13. A method as claimed in claim 11, providing notification of completion at the node originating the DMA request when transaction information is updated to indicate that fulfillment of the DMA request has been completed.

14. A method as claimed in claim 1, wherein the DMA request specifies reading of the data by the receiving node from the sending node.

15. A method as claimed in claim 14, further comprising storing transaction information for monitoring fulfillment of the read DMA request at the sending node and updating the transaction information stored at the sending node when transmitting each portion of the data.

16. A method as claimed in claim 15, wherein the transaction information is stored at the first and second nodes as DMA contexts.

17. A method as claimed in claim 16, wherein the DMA contexts are acquired by an upper level protocol layer (ULP) from a resource manager for the respective node, the ULP using the acquired DMA contexts to present DMA requests.

18. A method as claimed in claim 17, wherein the resource manager is a device driver of the network adapter.

19. A method as claimed in claim 1, wherein, except for receipt of the final portion of the data under the RDMA operation, the portion is received at the receiving node and the data is stored in the identified location therein without the network adapter posting an interrupt to the ULP of the receiving node.

20. Node communication system provided at a first node of a multi-processor system having a plurality of nodes connected by a network, the node communication system operable to transfer data by direct memory access (DMA) over a network between a memory of the first node and a memory of a second node of the multi-processor system, comprising:
a first network adapter at the first node, operable to transmit data stored in the memory of the first node to a second node in a plurality of portions in fulfillment of a DMA request, and to transmit each portion together with identifying information and information identifying a location for storing the portion in the memory of the second node, such that each portion is capable of being received independently by the second node according to the identifying information and each portion is capable of being stored in the memory of the second node at the location identified by the location identifying information.

21. A system as claimed in claim 20, wherein each portion is further capable of being received, validated and stored by the second node regardless of the order in which the portion is received by the second node in relation to other received portions.

22. A multi-processor system having a plurality of nodes interconnected by a network, comprising:
a first node;
a node communication system at the first node, operable to transfer data by direct memory access (DMA) over a network between a memory of the first node and a memory of a second node, including a first network adapter, operable to transmit data stored in the memory of the first node to a second node in a plurality of portions in fulfillment of a DMA request, to maintain first transaction information for monitoring the fulfillment of the DMA request, and to transmit each of the portions together with identifying information and information identifying a location for storing the portion in the memory of the second node;
a second node; and
a second network adapter at the second node, operable to store second transaction information for monitoring fulfillment of the DMA request at the second node, to receive and store each of the portions of the data in the memory of the second node according to the location identifying information, and to update the stored second transaction information after validating the received portion.

23. A multi-processor system as claimed in claim 22, wherein for each portion, the first network adapter is operable to transmit the identifying information and the location identifying information in a header, the header further referencing the first and second transaction information.

24. A multi-processor system as claimed in claim 23, further comprising a first upper layer protocol operating (ULP) on the first node, a second upper layer protocol (ULP) operating on the second node, wherein the first ULP is operable to initiate the DMA request, the first ULP specifying the first DMA context for storing the first transaction information and specifying the second DMA context for storing the second transaction information.

25. A multi-processor system as claimed in claim 24, wherein the first ULP is operable to specify the second DMA context prior to the first network adapter starting to transmit the portions of the data.

26. A multi-processor system as claimed in claim 24, wherein the first ULP is operable to specify a transaction identification (TID) when initiating the DMA request, the first network adapter being operable to transmit the TID with each transmitted portion of the data.

27. A multi-processor system as claimed in claim 26, wherein the second network adapter is operable to distinguish between a first portion transmitted in fulfillment of a first DMA request, based on a first TID transmitted therewith, and a second portion of data transmitted for a second DMA request, based on a second TID transmitted therewith, and when the second TID has higher value than the first TID, to detect that the second DMA request is more recent than the first TID.

28. A multi-processor system as claimed in claim 26, wherein the second adapter is operable to discard the portion transmitted for the first DMA request upon detecting that the first TID is invalid.

29. A multi-processor system as claimed in claim 24, wherein the first ULP is operable to indicate, of the DMA request, which of the first and second nodes is to be notified when fulfillment of the DMA request is completed.

30. A multi-processor system as claimed in claim 24, wherein the second network adapter is operable to store all of the portions of the data transmitted in fulfillment of the DMA request according to the location identifying information, despite the second network adapter receiving the portions out of the order in which they are transmitted.

31. A multi-processor system as claimed in claim 30, wherein the first network adapter is operable to transmit respective ones of the portions of the data over different paths of the network to the second network adapter.

32. A multi-processor system as claimed in claim 30, wherein the second network adapter is operable to automatically store the received portions of the data according to the location identifying information without the control of the second ULP over the storing.

33. A machine-readable recording medium having instructions recorded thereon for performing a method of transferring data by direct memory access (DMA) over a network between a memory of a first node of a multi-processor system having a plurality of nodes connected by a network and a memory of a second node of the multi-processor system, the method comprising:
presenting to a first node a request for DMA access with respect to the second memory of the second node;
transmitting data stored in the memory of a sending node selected from the first and second nodes to a receiving node selected from the other one of the first and second nodes in a plurality of portions in fulfillment of the DMA request, each portion transmitted together with identifying information and information identifying a location for storing the portion in the memory of the receiving node;
receiving at the receiving node at least a portion of the plurality of transmitted portions together with the identifying information and location identifying information; and
storing the data contained in the received portion at the location in the memory of the receiving node identified by the location identifying information.

34. A machine-readable recording medium as claimed in claim 33, wherein the method further comprises validating the received portion using the received identifying information prior to storing the received portion at the location in the memory of the receiving node.

35. A machine-readable recording medium as claimed in claim 34, wherein the method further comprises storing transaction information for monitoring fulfillment of the DMA request at the receiving node, and updating the stored transaction information at the receiving node after validating the received portion.

36. A machine-readable recording medium as claimed in claim 35, wherein the identifying information and the location identifying information are provided in a header transmitted with each portion, the header referencing the transaction information, the method further comprising, validating the header for each received portion with the transaction information stored at the receiving node and dropping the received portion when the transmitted header fails to validate.
